(19) United States
(12) Patent Application Publication
(10) Pub. No.: US 2012/0098757 A1
(43) Pub. Date: Apr. 26, 2012

(54) SYSTEM AND METHOD UTILIZING BOUNDARY SENSORS FOR TOUCH DETECTION

(76) Inventors: Ramin Samadani, Palo Alto, CA (US); Ton Kalker, Mountain View, CA (US); Robert Samuel Schreiber, Palo Alto, CA (US)

(21) Appl. No.: 12/912,477

(22) Filed: Oct. 26, 2010

(51) Int. Cl. G06F 3/041

(52) U.S. Cl. 345/173

(57) ABSTRACT

sensors are arranged continuously adjacent along the boundary region of a touch surface. Furthermore, a touch associated with the interior area of the touch surface is detected via at least a plurality of sensors along the boundary region.

### BACKGROUND

Providing efficient and intuitive interaction between a computing system and users thereof is essential for delivering an engaging and enjoyable user-experience. As computer systems have grown in popularity, however, alternate input and interaction systems have been developed. Today, most computer systems include a keyboard for allowing a user to manually input information into the computer system, and a mouse for selecting or highlighting items shown on an associated display unit.

Touch-based, or touchscreen, computer systems allow a user to physically touch the display unit and have that touch registered as an input at the particular touch location, thereby enabling a user to interact physically with objects shown on the display of the computer system. Multi-touch detection systems, in which multiple points of contact are detected, are being increasingly utilized for facilitating user interaction with touch-enabled display devices. Two common multi-touch designs, resistive or capacitive, detect resistance or capacitance changes across the entire surface in order to sense the locations of individual points of contact. Due to inherent limitations of these technologies, however, improved touch sensing mechanisms are sought.

### BRIEF DESCRIPTION OF THE DRAWINGS

The features and advantages of the inventions as well as additional features and advantages thereof will be more clearly understood'hereinafter as a result of a detailed description of particular embodiments of the invention when taken in conjunction with the following drawings in which:

FIGS. 1A-1D are three-dimensional perspective views of a touch surface utilizing boundary sensors in accordance with an example of the present invention.

FIG. 2 is a three-dimensional perspective view of a user operating a computing device utilizing boundary sensors according to an example of the present invention.

FIG. 3 is a simplified block diagram of a touch detection system incorporating boundary sensors in accordance with an example of the present invention.

FIGS. 4A and 4B are top down and enlarged views respectively of a physical contact on a touch surface having boundary sensors, while FIGS. 4C and 4D are side and enlarged views respectively of a physical contact on a touch surface having boundary sensors according to an example of the present invention.

FIGS. 5A-5B are simplified illustrations of a touch surface and continuously adjacent boundary sensors according to an example of the present invention.

FIGS. 6A-6C are various graphs illustrating a physical contact and boundary slope information in accordance with an example of the present invention.

FIG. 7 is a flow diagram of the processing steps for detecting a touch input in accordance with an example of the present invention.

### DETAILED DESCRIPTION OF THE INVENTION

The following discussion is directed to various embodiments. Although one or more of these embodiments may be discussed in detail, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Resistive and capacitive multi-touch detection systems include sensors throughout the front surface of the display device. Such a configuration increases the complexity of the system design and limits the types of materials that may be used since the electrical properties of some materials may negatively affect the performance of the system. Other touch-based systems utilize a small number of visual sensors such as optical or infrared sensors for example, positioned at edges of the display. However, these visual sensors suffer from blind spots or occlusion, in which an object touching the screen is blocked or occluded from view by another object. Still further, these sensors are only configured to work with planar displays. Accordingly, an improved and occlusion-free multi-touch detection system and method is needed in the art.

Examples of the present invention disclose a multi-touch detection system that uses mechanical sensors to detect changes in physical properties along the boundaries of the touch surface. According to one example, boundary information from the sensors is used to detect a touch anywhere in the interior of the touch surface. Furthermore, multiple simultaneous touch contacts may be individually resolved by the system and method of the present examples. Such a configuration allows for the inclusion of a touch-enabled interface in computing systems having curved or planar touch surfaces, while also helping to prevent the occurrence of occlusion (i.e. blind spots) present in prior touch display systems.

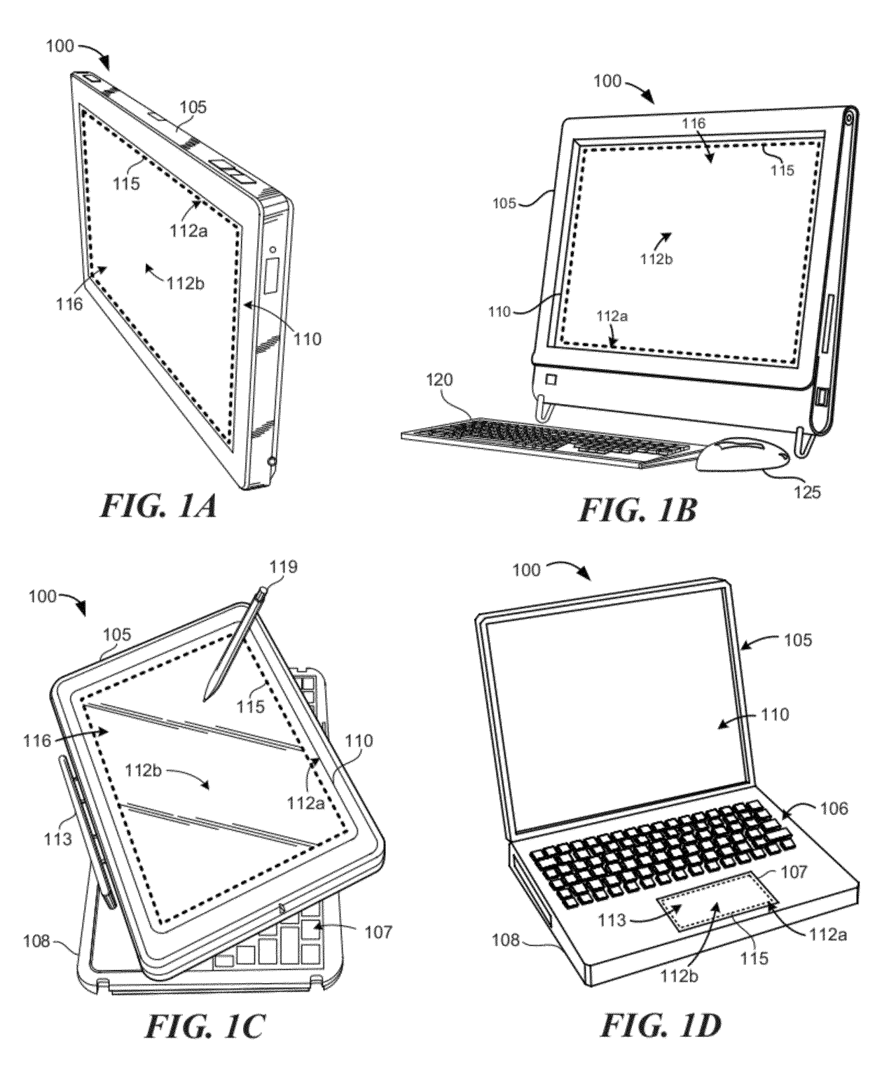

Referring now in more detail to the drawings in which like numerals identify corresponding parts throughout the views, FIGS. 1A-1D are three-dimensional perspective views of a touch surface utilizing boundary sensors in accordance with an example of the present invention. As shown in FIG. 1A, a computing device 100 includes a housing 105 for accommodating a display unit 110. Here, the computing device 100 is represented as a tablet personal computer. The display unit 110 includes a touch surface 116 having an outer boundary area 112a and an interior area 112b. In addition, a group of mechanical sensors 115 are formed around the outer boundary area 112a of the display unit 110. It is to be understood that the group of boundary sensors 115 will be formed at the boundary region 112a of the touch surface 116 or very close to the boundary region 112a depending on the way the touch surface 116 is mounted on the display unit 110 (e.g. clamped, simply supported, etc.). According to one example, boundary sensors 115 are configured to detect a physical contact, or touch, within the interior area 112b of the display unit 110 as will be described in further detail below. Similarly, FIG. 1B depicts another computing device incorporating the touch detection system in accordance with an example of the present invention. In the present example, the computing device 100 is represented as an all-in-one personal computer. As in the previous embodiment, the computing device 100 includes a housing 105 for accommodating a display unit 105. In addition, the computing device includes alternate input mechanisms such as a keyboard 120 and a mouse 125. The display unit includes a touch surface 116 having an outer perimeter region 112a and an interior region 112b that lies within the outer perimeter 112a. Still further, a plurality of sensors 115 are formed along the outer perimeter region 112a of the display unit 110 and are configured to detect the presence of a touch on the interior region 112b.

FIG. 1C depicts a convertible laptop computer as the computing device in accordance with an example of the present invention. In particular, the computing device 100 includes a base housing 108 having an input means such as a physical keyboard 107, and a display housing 105 for encompassing a touch-enabled display unit 110. The touch-enabled display unit 110 includes electrical wiring adapted to provide graphical display to a user on a contact surface side 116. Moreover, a stylus 119 may be used as an input device for physically contacting a touch surface 116 of the display unit 110. In the present example, the display housing 105 is configured to rotate and fold downward from an upright position with respect to the base housing 108 via a hinge pivot assembly 113. As shown here, a group of adjacent and continuous sensors 115 are formed along the outer boundary region 112a of the display unit 110. Upon receiving contact on the touch surface 116 via the stylus 119 or a user's hand for example, the location and pressure of the physical contact may be determined using the group of boundary sensors 115.

With respect to FIG. 1D, a notebook computer 100 represents the computing device implementing the boundary touch detection system in accordance with an example of the present invention. As shown here, the notebook computer 100 includes a chassis having an upper housing 105 pivotally connected to a base housing 108. The upper housing, or display panel housing 105, includes a display device 110, while the base housing 108 includes a user input means for facilitating manual operation and input by a user such as a keyboard 106 and touch pad 107. In addition to formation of boundary sensors 115 around the outer perimeter of a display unit 110 as in the previous embodiments, the boundary sensors 115 may also be formed along the outer boundary area 112a of a touch pad 107. As such, the touch surface 113 of the present example represents a contact and non-displayable surface. In the present example, such a configuration enables a physical touch and associated movement on the interior area 112b of the touch pad 107 to be easily detected by the system using only the boundary sensors 115 formed along the outer boundary of the touch pad surface 113.

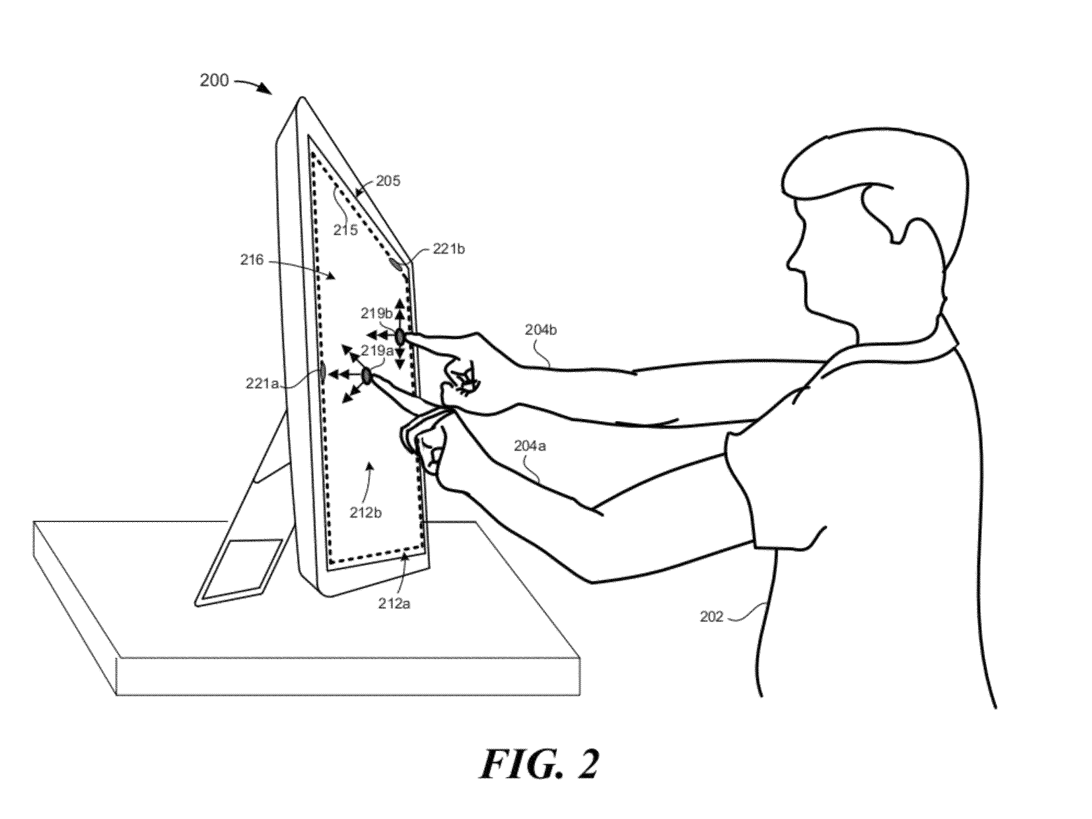

FIG. 2 is a three-dimensional perspective view of a user operating a computing device utilizing boundary sensors according to an example of the present invention. As shown here, a user 202 interacts with a multi-touch detection system 200 including a display unit 205, touch surface 216, and boundary sensors 215 formed along the outer periphery 212a of the touch surface 216. In the present example, the user 202 physically contacts the touch surface 216 of the display unit 205 with one finger from their left hand 204a and one finger from their right hand 204b. The finger of each hand 204a and 204b contacts the interior area 212b of the touch surface 216 at touch points 219a and 219b respectively. Physical contact on the interior region 212b of the touch surface 216 causes simultaneous movement or bending throughout the touch surface material as indicated by the directional arrows stemming away from touch points 219a and 219b shown in FIG. 2. Still further, such bending movement may be detected by a subset of boundary sensors (i.e. a plurality of sensors less than the complete group of boundary sensors) or the entire group of boundary sensors 215 simultaneously. In the present example, a subset of boundary sensors 221a detect the change in boundary condition caused by the physical contact at touch point 219a, while a subset of boundary sensors 221b detect the change in boundary condition caused by the physical contact at touch point 219b. For example, a change in the displacement, slope, and/or curvature of the material at the boundary area/region may be detected by the subset of boundary sensors 221a and 221b. However, these particular subsets of boundary sensors 221a and 221b are simply used for illustration purposes only, as any subset or the complete group of boundary sensors may detect the change in boundary condition caused by a user's physical contact. Based on the detected change in boundary condition (e.g. displacement, slope, and/or curvature), the location and strength of the physical contact on the interior area 212b of the touch surface 216 may be determined. Since the multi-touch detection system of the present example utilizes mechanical sensors arranged continuously adjacent along the outer boundary of the touch surface, the precise location of multiple impulsive forces can be detected for the interior of the display. Accordingly, there are no blind spots or occlusion issues as present in prior touch detection systems and methods.

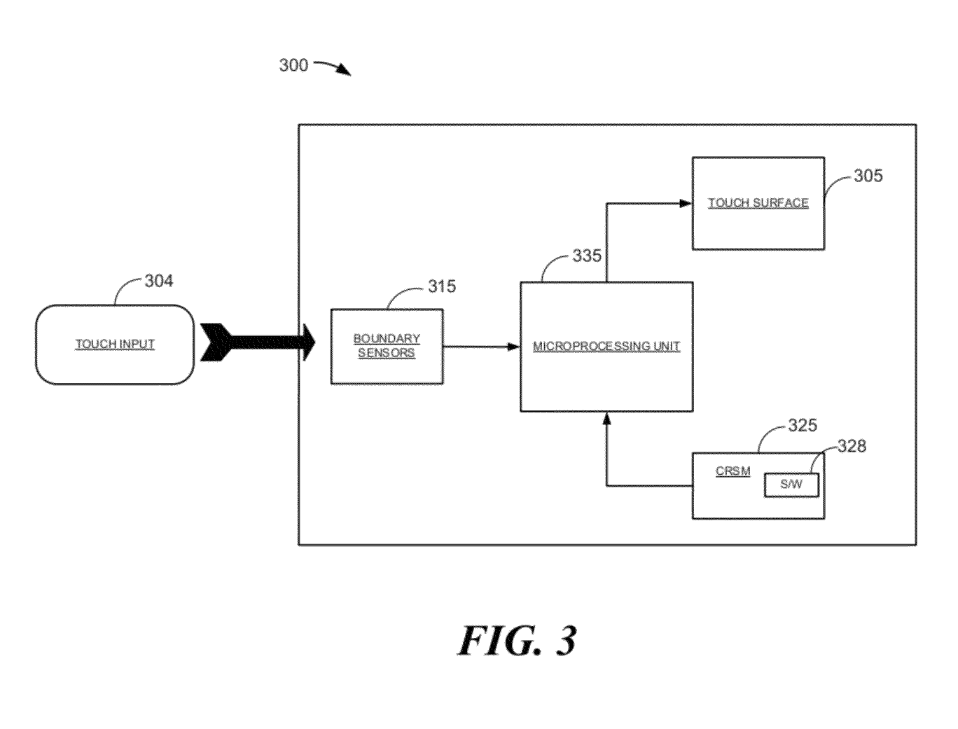

FIG. 3 is a simplified block diagram of a touch detection system incorporating boundary sensors in accordance with an example of the present invention. As shown in this example, the system 300 includes a microprocessing unit 335 coupled to a touch surface 305, boundary sensors 315, and a computer-readable storage medium 322. The microprocessing unit 335 represents a central processing unit configured to execute program instructions. Touch surface 305 represents any surface utilized for receiving touch input from a user including, but not limited to, an electronic visual display configured to display graphical information, a touchpad for controlling a pointer associated with a display, or a presentation canvas such as an interactive whiteboard for example. Furthermore, boundary sensors 315 represent a group of mechanical sensors configured to detect slope, displacement, and/or curvature of an adjacent surface material. For example, the stress (i.e. force) strain (i.e. displacement) properties of the touch surface material may be measured by the sensors 315 and calculated by the microprocessor using partial differential equations. Such differential equations may include, but are not limited to, the second order Poisson equation for resolving specific properties of linear membrane materials, and the fourth order Biharmonic equation with a forcing term for resolving specific properties of linear plate materials for example.

Storage medium 322 represents volatile storage (e.g. random access memory), non-volatile store (e.g. hard disk drive, read-only memory, compact disc read only memory, flash storage, etc.), or combinations thereof. Furthermore, storage medium 324 includes software 324 that is executable by the microprocessing unit 335 and, that when executed, causes the microprocessing unit 335 to perform some or all of the functionality described herein.

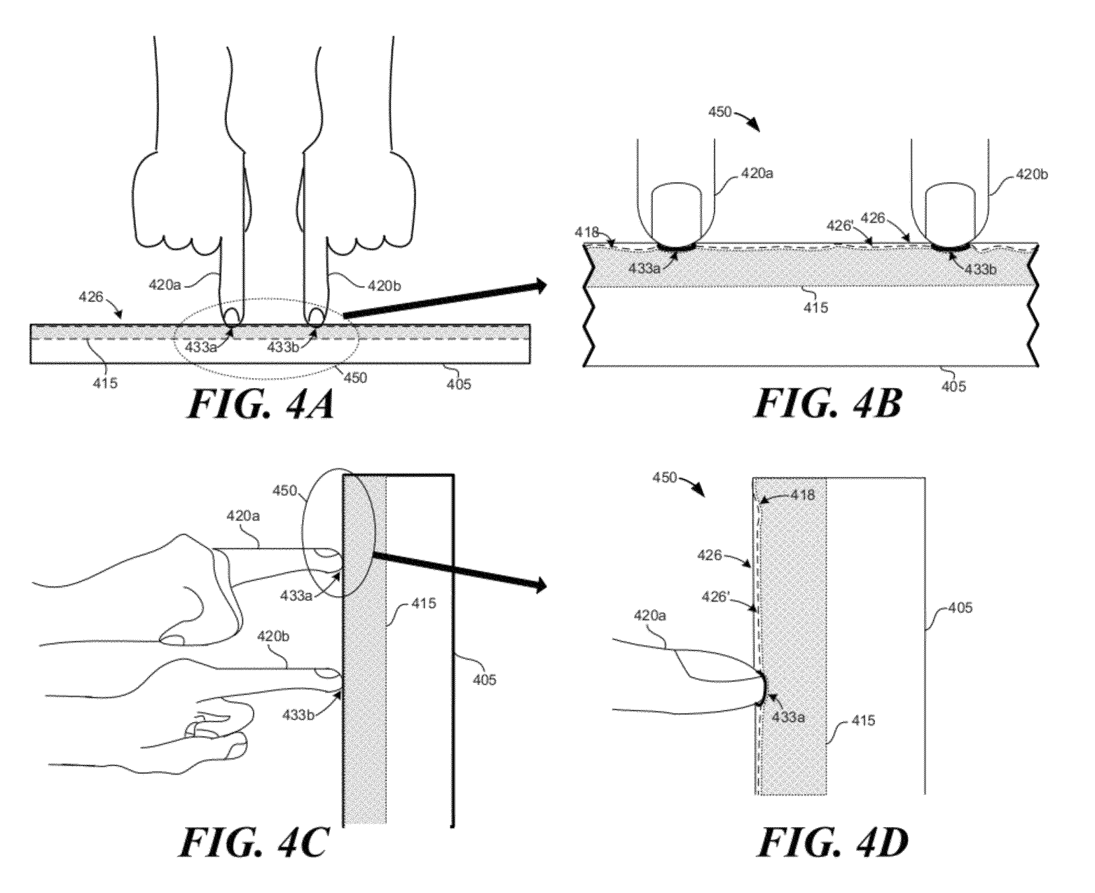

FIGS. 4A and 4B are top down and enlarged views respectively of a physical contact on a touch surface having boundary sensors, while FIGS. 4C and 4D are side and enlarged views respectively of a physical contact on a touch surface having boundary sensors according to an example of the present invention. FIG. 4A is a top down view of a physical contact on the interior area of the touch surface. As shown here, a multiple fingers 420a and 420b from a user physically contact a front area of the touch surface 426 of the display unit 405. In the present example, a group of mechanical sensors 415 are positioned behind the front area of the touch surface 426 and formed continuously adjacent along the outer boundary thereof. Additionally, a plurality or a subset of the group of boundary sensors 415 are utilized to detect the physical contact at touch points 433a and 433b. As shown in the enlarged view of FIG. 4B, the physical contact of fingers 420a and 420b causes the material of the touch surface 426 to deform and bend inwards at touch points 433a and 433b. Correspondingly, the boundary conditions of the touch surface 416 change as indicated by the dotted line 426′. Boundary sensors 415 are configured to detect this change 426′ in boundary condition at position 418 for example, and the detected boundary variance (i.e. instance of change or variation in boundary condition) is used by the microprocessor to detect the properties (e.g. location and/or pressure) of touch points 433a and 433b.

FIG. 4C is a side view of a physical contact on the interior area of the touch surface. As in the previous embodiment, the operating environment depicts multiple fingers 420a and 420b from a user that physically contact a front area of the touch surface 426 of the display unit 405 at touch points 433a and 433b. A plurality of continuous string of adjacent mechanical sensors 415 are positioned along the outer boundary of and in physical contact with the touch surface 426 of the display unit 405. Turning now to the enlarged view of FIG. 4D, the physical contact of finger 420a on the touch surface 426 causes the physical properties of the material of the touch surface 426 to also change as indicated by the dotted line 426′. As a result, at least one sensor of the plurality of adjacent boundary sensors 415 detects the physical change 426′ of the touch surface material at the outer boundary 418 for example. The detected change in boundary condition 418 is then utilized by the microprocessor to detect at least one property (e.g. location) of the touch point 433a.

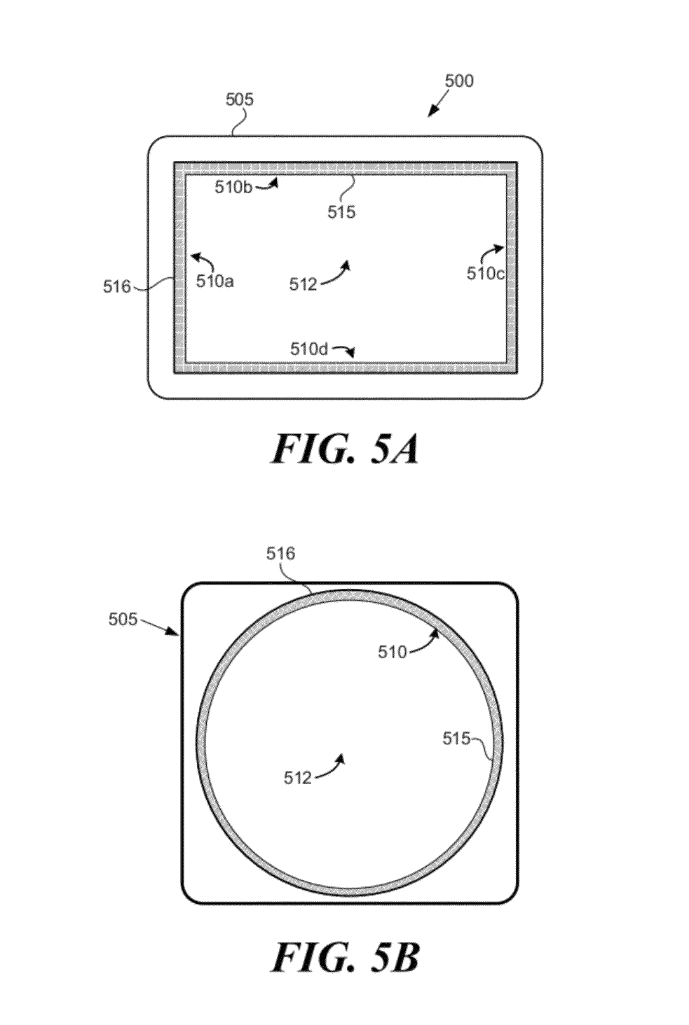

FIGS. 5A-5B are illustrations of a touch surface and continuously adjacent boundary sensors according to an example of the present invention. As shown in FIG. 5A, the touch surface 516 includes four outer side areas 510a-510d forming a rectangular-shaped surface, and an interior surface 512 within the outer side areas 510a-510d. A plurality of mechanical sensors 515 are formed adjacent and continuously along all four outer side areas 510a-510d of the touch surface 516. More specifically, the sensors 515 are densely populated, or numerous and sufficiently close enough along the outer side areas 510a-510d so as to detect multiple touch points at any position on the interior area 512 of the touch surface 516. In addition, formation along the outer sides 510a-510d includes at the outer border of the touch surface 516 or in close proximity to the outer border of the touch surface depending on the mounting method of the touch surface 516 (e.g. clamped, simply supported, etc.). Furthermore and in accordance with one example, the touch surface 516 represents a thin rectangular plate resistive to bending. The thin plate may be mounted to the housing 505 via a simply supported means (i.e. capable of rotation around the boundary) or via a clamped means. In each mounting scenario, the change in displacement and/or curvature may be measured by the boundary sensors for determining touch point properties on the interior surface.

FIG. 5B depicts a touch surface in accordance with another example of the present invention. As shown where, the touch surface 516 is circular-shaped and mounted or attached to a frame or housing 505. Furthermore, a plurality of sensors 516 configured to measure boundary conditions of the touch surface 516 are positioned along the outer periphery, or circumference of the touch surface 516. In the present example, the circular touch surface 516 is comprised of membrane material resistive to stretching. In such a configuration, a change in slope at the boundary of the membrane material of the touch surface 516 would be used for determining touch point properties on the interior surface. Though FIGS. 5A and 5B depict two examples of touch surfaces, the present invention is not limited thereto. For example, the touch surface 516 may consist of any shaped surface conducive to the formation of mechanical sensors along its boundary.

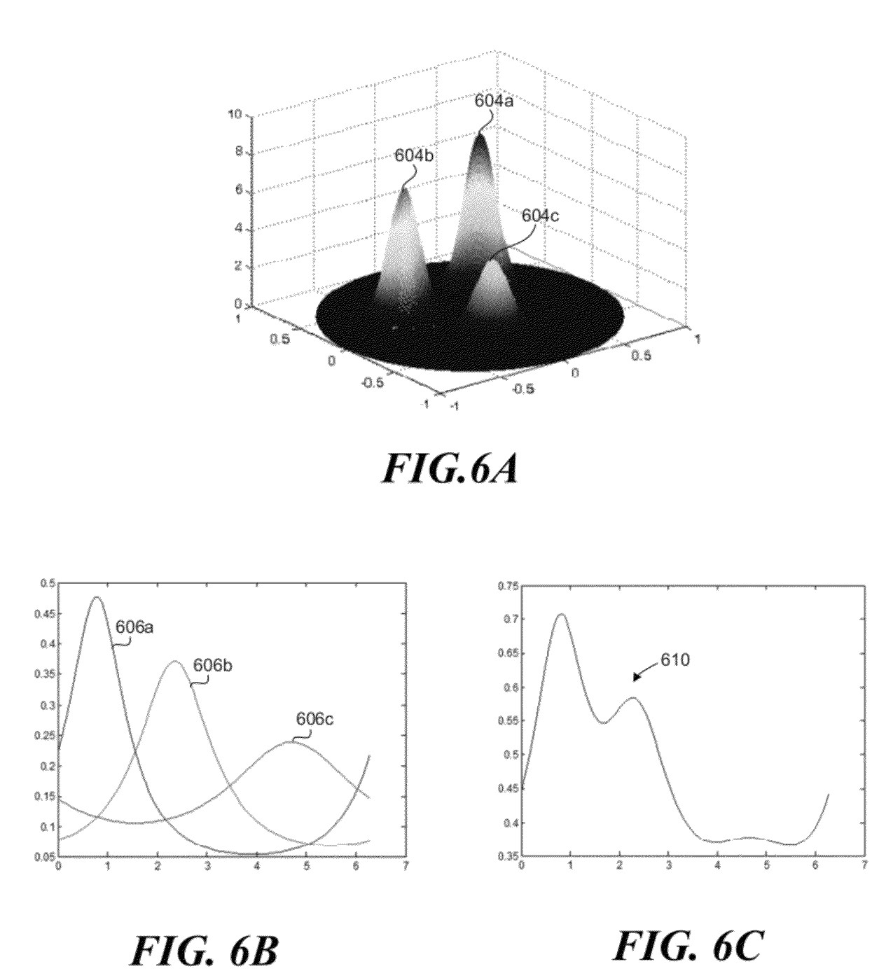

FIGS. 6A-6C are various graphs illustrating a physical contact and boundary slope information in accordance with an example of the present invention. As shown in FIG. 6A, three simulated “fingers” come into contact and exert inward force on a touch surface. Here, the three-dimensional graphical simulation depicts three inward forces 604a-604c caused by physical contact of the fingers on the touch surface. FIG. 6B is a graph depicting the changes in boundary slopes caused by the forces 604a-604c shown in FIG. 6A. That is, FIG. 6B depicts individual boundary slopes 606a-606c that arise from the physical contact of each simulated “finger” and the corresponding forces 604a-604c. Here, the horizontal axis represents the location (angle in radians) of the point on the boundary, while the vertical axis represents the slope at that point on the boundary. Furthermore, the sum of the boundary slopes 606a-606c shown in FIG. 6B result in the slope 610 of FIG. 6C. According to one example, slope 610 represents the boundary condition that is actually sensed by at least a subset of boundary sensors since the slopes of the individual fingers will be summed in the linear model of the present example. As shown and described above with respect to FIGS. 6A-6C, and in particular FIG. 6B, each physical contact results in condition changes (i.e. slope, displacement, and/or curvature) throughout the boundary, thereby eliminating occlusion effects in the multi-touch detection system in accordance with examples of the present invention.

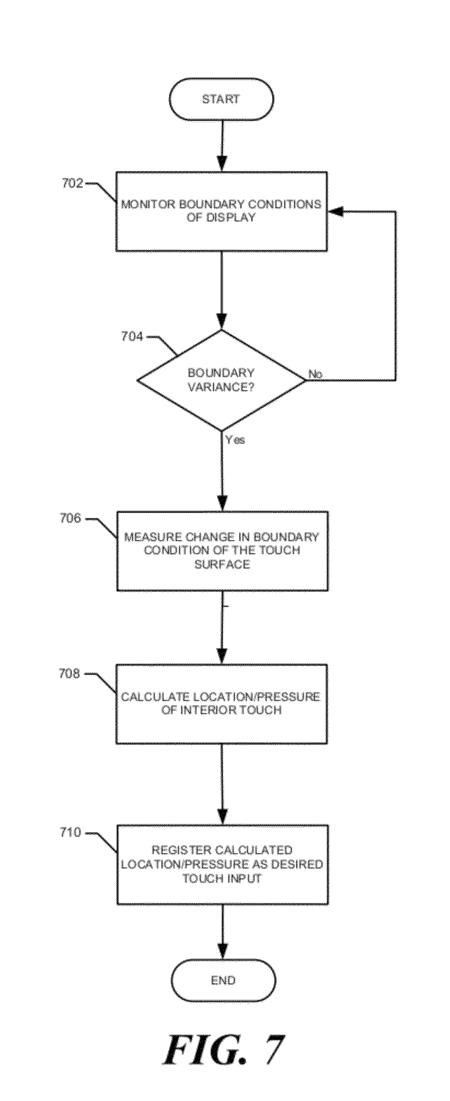

FIG. 7 is a flow diagram of the processing steps for detecting a touch input in accordance with an example of the present invention. In step 702, the boundary conditions of the display surface are monitored via a set of continuously adjacent mechanical sensors. When a change in boundary condition is detected in step 704, the microprocessor measures the boundary variance received from the subset or plurality of sensors within the set of boundary sensors. Depending on the surface material (e.g. membrane or plate), the boundary information will comprise of displacement, slope and/or curvature data as a function of time relating to the physical change at the boundary area of the touch surface. In one example, the boundary information is analyzed together with apriori information about the types of solutions that are physically possible, namely the relative size of fingers or stylus tip (i.e. small area), fingers of one hand form a connected region, and inward force (i.e. positive numbers). The boundary information received from the subset of sensors is then calculated in step 708 to determine the location and/or pressure of the physical contact on the interior area of the touch surface. Next, in step 710, the calculated location and/or pressure of the physical contact is registered by the microprocessor as a desired touch input that causes a control operation to be executed on the computing system. For example, pressing on the touch surface with a finger or stylus would cause the microprocessor to register the touch input as a selection operation for a given object displayed on the touch surface. In another example, contacting the touch surface with a thumb and forefinger held apart and then pinching them together may cause the microprocessor to register the touch input as a pinch and drag operation for a given object displayed on the touch surface.

Examples of the present invention provides a system and method that determines the forces or deformations applied at multiple points in the interior of a touch surface by measuring displacements, slopes and/or curvatures only on the boundaries of the touch surface. In addition, several advantages are afforded by the multi touch detection system of the present examples. For example, since sensors are only present along or near (inside or outside, depending on the mounting method) the boundary and not the interior, many different types of materials and configurations may be utilized such as a projection screen or walls for example. Moreover, blind spots and occlusion problems that plague camera-based touch systems are eliminated. Furthermore, the multi-touch detection system and method of the present examples may be successfully applied to arbitrarily shaped touch surfaces such as curved or sloped display devices. Still further, since mechanical sensors are utilized herein, electrical properties of the surface material are irrelevant.

Furthermore, while the invention has been described with respect to example embodiments, one skilled in the art will recognize that numerous modifications are possible. For example, although embodiments depict as several computing environments, the invention is not limited thereto. For example, the multi-touch detection system may be applied to a netbook computer, a smartphone, a projector screen, or any other environment utilized for touch-based interaction.

Furthermore, the multi-touch detection system may include at least one sensor positioned within the interior area of the touch surface. Such a configuration may provide additional information regarding the properties of the internal touch point. Thus, although the invention has been described with respect to exemplary embodiments, it will be appreciated that the invention is intended to cover all modifications and equivalents within the scope of the following claims.

What is claimed is:

1. A system, comprising:
a touch surface including a boundary region and an interior area; and
a group of sensors arranged continuously adjacent along the boundary region of the touch surface, wherein at least a plurality sensors of the group of sensors are configured to detect a touch input associated with the interior area of the touch surface.

2. The system of claim 1, further comprising:
a processing unit coupled to the group of sensors and configured to measure boundary information associated with the boundary region of the touch surface.

3. The system of claim 2, wherein the processing unit is further configured to calculate a location and/or pressure associated with the touch input on the interior area of the touch surface based on measured boundary information received from the plurality of sensors from the group of sensors.

4. The system of claim 1, wherein the group of sensors are configured to detect multiple simultaneous touch points.

5. The system of claim 1, wherein the touch surface is comprised of a membrane or plate material.

6. The system of claim 5, wherein the group of sensors represent a continuous string of adjacent mechanical sensors positioned along the outer perimeter of the touch surface.

7. A method for providing multi-touch detection, the method comprising:
monitoring, via a set of sensors arranged along a perimeter of a touch surface, a boundary condition of the perimeter of the touch surface;
measuring, via a processing unit coupled to the set of sensors, a change in the boundary condition of the perimeter of the touch surface; and
determining the presence of a physical touch on an interior area of the touch surface based on the measured change in boundary condition associated with the perimeter of the touch surface.

8. The method of claim 7, further comprising:
calculating a location and/or pressure of the physical touch based on the measured change in boundary condition.

9. The method of claim 8, further comprising:
registering the calculated location and/or pressure of the physical touch as a desired touch input that causes a control operation to be executed on the computing system.

10. The method of claim 7, further comprising:
detecting, via a subset of sensors of the set of sensors, multiple simultaneous physical touches on the interior area of the touch surface.

11. The method of claim 7, wherein the touch surface is comprised of a plate material or a membrane material.

12. The method of claim 11, wherein the step of calculating a location and/or pressure of the physical touch further comprises:
measuring a change in displacement, slope and/or curvature of the material of the touch surface at the perimeter thereof caused by the physical touch on the interior area of the touch surface.

13. A computer readable storage medium having stored executable instructions, that when executed by a processor, causes the processor to:
receive boundary information from a plurality of sensors arranged around a perimeter of a touch surface;
measure a boundary variance on the perimeter of the touch surface based on the received boundary information; and
determine the presence of a physical touch on an interior area of the touch surface based on the measured boundary variance associated with the perimeter of the touch surface.

14. The computer readable storage medium of claim 13, wherein then the executable instructions further cause the processor to:
calculate a location and/or pressure of the physical touch based on the measured boundary variance associated with the perimeter of the touch surface.

15. The computer readable storage medium of claim 14, wherein the executable instructions further cause the processor to:
register the calculated location and/or pressure of the physical touch as a desired touch input that causes a control operation to be executed on an associated computing system.
